(19) United States
(12) Patent Application Publication
(10) Pub. No.: US 2025/0201864 A1
(43) Pub. Date: Jun. 19, 2025

(54) BATTERY

(71) Applicant: Panasonic Intellectual Property Management Co., Ltd., Osaka (JP)

(72) Inventor: EIICHI KOGA, Hokkaido (JP)

(21) Appl. No.: 19/045,619

(22) Filed: Feb. 5, 2025

Related U.S. Application Data
(63) Continuation of application No. PCT/JP2023/021785, filed on Jun. 12, 2023.

(30) Foreign Application Priority Data
Aug. 25, 2022 (JP) 2022-134527

(51) Int. Cl. H01M 4/66; H01M 4/13; H01M 10/0585; H01M 10/42

(52) U.S. Cl. CPC H01M 4/661; H01M 4/13; H01M 4/666; H01M 4/667; H01M 4/668; H01M 10/0585; H01M 10/4235

(57) ABSTRACT

A battery according to this disclosure includes a first electrode, a second electrode, and an electrolyte. The first electrode includes a first current collector and a first active material layer, the first current collector is formed of a green compact including first metal particles, the first metal particles each have a first protection layer on at least a portion of a surface of the first metal particle, and the first protection layer includes an oxide.

### BACKGROUND

### 1. Technical Field

The present disclosure relates to a battery.

### 2. Description of the Related Art

Techniques for decreasing the size, improving performance, and laminating layers of a battery are in demand. As such Techniques related to a battery, Japanese Unexamined Patent Application Publication No. 2009-193802 discloses a battery including a current collector formed by compacting a current collector forming powder. The battery described in Japanese Unexamined Patent Application Publication No. 2009-193802 has this configuration to increase the contact area between the current collector and the electrode active material layer to reduce the internal resistance, and thus the battery has higher battery performance.

### SUMMARY

In the prior art, improvement in battery reliability is also in demand.

One non-limiting and exemplary embodiment provides a battery that includes a current collector formed by compacting a powder and has improved reliability.

In one general aspect, the techniques disclosed here feature a battery including a first electrode, a second electrode, and an electrolyte, wherein the first electrode includes a first current collector and a first active material layer, the first current collector is formed of a green compact including first metal particles, the first metal particles each have a first protection layer on at least a portion of a surface of the first metal particle, and the first protection layer includes an oxide.

The present disclosure can improve reliability of a battery including a current collector formed by compacting a powder.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates a cross-sectional view and a plan view each illustrating a schematic configuration of a battery according to a first embodiment;

FIG. 2 is a magnified view of a portion around a grain boundary triple point of a green compact forming the current collector;

FIG. 3 illustrates a cross-sectional view and a plan view each illustrating a schematic configuration of a battery according to a second embodiment;

FIG. 4 illustrates a cross-sectional view and a plan view each illustrating a schematic configuration of a battery according to a third embodiment;

FIG. 5 illustrates a cross-sectional view and a plan view each illustrating a schematic configuration of a battery according to a fourth embodiment;

FIG. 6 illustrates a cross-sectional view and a plan view each illustrating a schematic configuration of a battery according to a fifth embodiment; and

FIG. 7 illustrates a cross-sectional view and a plan view each illustrating a schematic configuration of a battery according to a sixth embodiment.

### DETAILED DESCRIPTIONS

Hereinafter, embodiments of the present disclosure will be described in detail with reference to the drawings.

The embodiments described below are all general or specific examples. The numbers, shapes, materials, positions of the components, connections between the components, production process, and order of the production process in the following embodiments are examples and should not be construed as limiting of the disclosure. Among the components of the embodiments described below, components that are not described in the independent claim, which includes the broadest concept, will be described as optional components.

In this specification, terms indicating shapes of components such as rectangular and numerical ranges are not strictly limited to the meanings of the terms and the ranges. The terms and the ranges may include approximation, such as variations of a few percent. The drawings are schematic views and are not necessarily accurate. Accordingly, in the drawings, components are not necessarily to scale. In the drawings, the same reference numerals are assigned to the components having substantially the same configuration without duplicated or detailed explanation.

In the specification and the drawings, the x, y, and z axes are three axes of a three-dimensional orthogonal coordinate system. In the embodiments, the z direction corresponds to the thickness direction of the battery. In the specification, the “thickness direction” is a direction perpendicular to the plane on which layers of the battery are laminated, unless otherwise specified.

In the specification, when the battery is viewed in “plan view”, the battery is viewed in the laminating direction of layers. In this specification, the “thickness” is a dimension of the battery and the layers measured in the laminating direction.

In this specification, “side surfaces” of the battery and the layers refer to surfaces extending in the laminating direction of the layers of the battery, and “main surfaces” refer to surfaces other than the side surfaces, unless otherwise specified.

In this specification, when the battery is viewed in the laminating direction of the layers of the battery, “inner” of “inner side” refers to a central side of the battery, and “outer” of “outer side” refers to an outer peripheral side of the battery.

In the specification, the terms “upper” and “lower” used to describe the configuration of the battery are not meant to refer to the upward direction (vertically upward) and the downward direction (vertically downward) in absolute spatial awareness. The terms are defined by the relative positional relationship based on the laminating order in the laminate. Furthermore, the terms “upper” and “lower” are used not only for a case where two components are spaced apart from each other with another component being interposed therebetween but also for a case where two adjacent components are in contact with each other.

### First Embodiment

Hereinafter, a battery according to a first embodiment will be described.

A battery according to the first embodiment includes a first electrode, a second electrode, and an electrolyte. The battery according to the first embodiment includes a solid electrolyte layer that includes, for example, a solid electrolyte as the electrolyte. The solid electrolyte layer is located between the first electrode and the second electrode. The first electrode includes a first current collector and a first active material layer. The first current collector is formed of a green compact including first metal particles. The first metal particles each have a first protection layer on at least a portion of a surface of the first metal particle, and the first protection layer includes an oxide.

As described above, in the battery according to the first embodiment, the first current collector of the first electrode is formed of a green compact including first metal particles, and the first metal particles each have a first protection layer including an oxide on at least a portion of the surface. This configuration enables the first current collector, which is a current collector formed by compacting a powder, to have higher corrosion resistance to, for example, gas components and solvents, resulting in improvement of the reliability of the current collector. This enables the battery according to the first embodiment, which is a battery having a current collector formed by compacting a powder, to have improved reliability.

Furthermore, the first current collector is formed of a green compact. This configuration enables the first current collector to be less damaged in handling and less warped, even when made thin, than a current collector formed of a thin metal foil or the like. Thus, the first current collector has higher reliability than a current collector formed of a thin metal foil or the like and can be thinner while maintaining the high reliability. A current collector formed of a thin metal foil or the like is more likely to be damaged in handling and warped when the thickness is reduced, resulting in difficulty of thickness reduction. The battery according to the first embodiment can have a smaller size, a larger capacity, and a higher energy density than a battery including a current collector formed of a thin metal foil or the like.

As above, the battery according to the first embodiment can have high reliability and further can have a smaller thickness, a larger capacity, and a higher energy density.

The electrolyte may be an electrolyte solution or other electrolytes. The electrolyte solution may be placed in a casing that houses the first and second electrodes. The battery may have a separator positioned between the first electrode and the second electrode. The separator may be an insulating material and may be impregnated with an electrolyte solution. The second electrode may have the same configuration as the first electrode. In other words, the second electrode may include a second current collector and a second active material layer, and the second current collector may have the same configuration as the first current collector, i.e., may be formed of a green compact of a first metal particle having a first protection layer on at least a portion of its surface.

Hereinafter, an example of the configuration of the battery according to the first embodiment will be described.

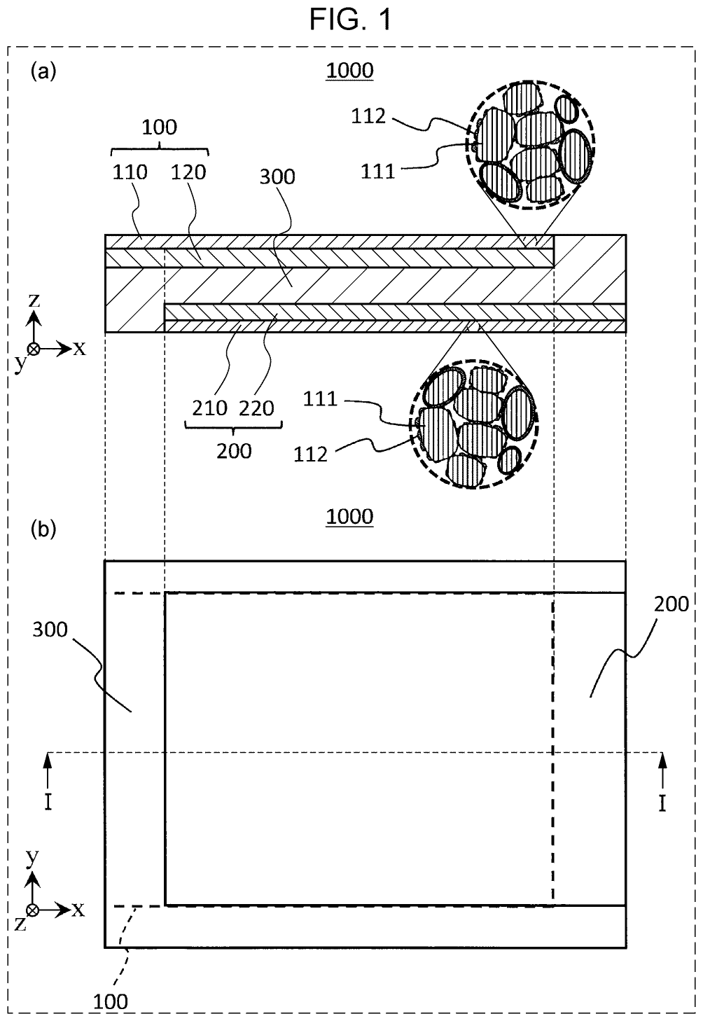

FIG. 1 illustrates a cross-sectional view and a plan view each illustrating a schematic configuration of a battery 1000 according to the first embodiment.

FIG. 1(a) is a cross-sectional view of the battery 1000 according to the first embodiment. FIG. 1(b) is a plan view of the battery 1000 according to the first embodiment viewed from below in the z direction. FIG. 1(a) illustrates a cross section taken along line I-I in FIG. 1(b).

As illustrated in FIG. 1, the battery 1000 includes a first electrode 100, a second electrode 200, and a solid electrolyte layer 300 between the first electrode 100 and the second electrode 200. Hereinafter, a laminate composed of the first electrode 100, the solid electrolyte layer 300, and the second electrode 200 may be referred to as a battery element.

The first electrode 100 includes a first current collector 110 and a first active material layer 120 in contact with the first current collector 110.

The first current collector 110 is formed of a green compact including first metal particles 111. The first metal particles 111 each have a first protection layer 112 on at least a portion of the surface. This first protection layer 112 includes an oxide.

The second electrode 200 faces the first electrode 100 and has the opposite polarity from that of the first electrode. For example, if the first electrode 100 is positive, the second electrode is negative.

The second electrode 200 includes, for example, a second current collector 210 and a second active material layer 220 in contact with the second current collector 210. The second current collector 210 may have the same configuration as the first current collector 110. Specifically, the second current collector 210 may be formed of a green compact including first metal particles 111 each having a first protection layer 112 on at least a portion of the surface.

In this specification, the first current collector 110 and the second current collector 210 may be collectively and simply referred to as a “current collector”.

In this specification, the first active material layer 120 and the second active material layer 220 may be collectively and simply referred to as an “active material layer”.

As illustrated in FIG. 1(b), each of the first current collector 110, the first active material layer 120, the solid electrolyte layer 300, the second active material layer 220, and the second current collector 210 may be rectangular in plan view. The first current collector 110, the first active material layer 120, the solid electrolyte layer 300, the second active material layer 220, and the second current collector 210 each may have a shape in plan view other than a rectangular shape.

The components of the battery 1000 will be described below.

### Current Collector

In the following example, the second current collector 210 has the same configuration as the first current collector 110, i.e., the second current collector 210 is also formed of a green compact including the first metal particles 111.

The current collector is formed of a green compact including the first metal particles 111. The current collector formed of such a green compact can be formed, for example, by printing a paste including the first metal particles 111 in a predetermined shape (e.g., a thin-film shaped rectangular pattern as illustrated in FIG. 1) and then pressing the resulting film against the solid electrolyte layer 300. In this method, for example, pressing the resulting film against the solid electrolyte layer 300 can form a green compact. In this specification, a green compact is a green compact formed by press-forming a material including particles into a predetermined shape. A green compact may be, for example, a pressed structure in which a powder material is press-formed into a predetermined shape so that the particles are in close contact with each other.

The green compact forming the current collector may further include a material other than the first metal particle 111. The green compact may include, for example, a second metal particles that include a different metal from the metal forming the first metal particles 111. In other words, the green compact may be formed of a composite metallic material including the first metal particles 111 and the second metal particles. When the green compact includes the first metal particles 111 and the second metal particles, properties of the current collector can be controlled in various ways. For example, the presence of the second metal particles enables the current collector to have properties that cannot be provided by a metallic material having a single composition, such as mechanical properties, electrochemical properties, and thermal expansion coefficient.

If the green compact includes the second metal particles, the second metal particles may have a smaller average particle diameter than the first metal particles 111. With this configuration, the second metal particles can readily fill the voids between the first metal particles 111 in the green compact. Thus, a compact current collector that includes a composite metallic material including the first metal particles 111 and the second metal particles can be produced. This enables a current collector that has less resistance loss to be produced, and thus a higher-performance battery can be produced.

Here, the average particle diameter of the first metal particles 111 and that of the second metal particles can be calculated by using an electron microscope image of a cross section of the current collector. Specifically, the average particle diameter is determined from the observation surface using the intercept method. The number of particles should be greater than or equal to 10, and voids should be excluded.

The first metal particle 111 and the second metal particle can be distinguished from each other by shading in a backscattered electron SEM image or from a surface analysis image of elemental analysis such as SEM-EDS and EPMA. These methods can also be used to distinguish the protection layer from the metal portion of the metal particle. The shading in the backscattered electron SEM image is caused by difference in molecular weight.

When the green compact includes the second metal particles, the second metal particles may have a different hardness than the first metal particles. This configuration makes it possible to control the microstructure of the composite metallic material including the first and second metal particles, enabling control of the packability of the green compact under pressure. Thus, the density and mechanical properties of the current collector can be controlled.

Here, the hardness of the first metal particles 111 and the second metal particles in the green compact can be checked by evaluating the first metal particles 111 and the second metal particles exposed on the cross section of the current collector cut flat, for example, by ion milling, by a Micro Vickers hardness test. For the same pressure, the larger the indentation, the softer it is considered.

The second metal particles may be softer than the first metal particles 111. In this case, during application of pressure to produce the green compact, the second metal particles can deform first to fill the voids between the first metal particles 111. This increases the compactness of the composite metallic material including the first metal particles 111 and the second metal particles, i.e., the compactness of the green compact, enabling a current collector having high conductivity and high corrosion resistance to be produced. Furthermore, the second metal particles in the composite metallic material can absorb stresses caused by thermal expansion of the first metal particles 111 and charging and discharging. Thus, a current collector having high temperature cycling durability and charge and discharge cycling durability can be produced.

The second metal particles may be harder than the first metal particles 111. In this case, application of pressure to produce a green compact forms a microstructure in which the second metal particle between the first metal particles 111 has a portion embedded in the first metal particle. Thus, the second metal particle acts as an anchor connecting the first metal particles 111, enhancing the connection between the first metal particles 111. This improves resistance of the current collector to deflection (e.g., bending) stress and handling, improving the mechanical reliability of the current collector. In other words, a battery having high mechanical reliability can be produced.

The second metal particles may have a different potential than the first metal particles 111. With this configuration, the electrochemical stability of the current collector can be adjusted. Furthermore, for example, the current collector may have a two-layer structure including a layer of the first metal particles 111 and a layer of the second metal particles such that upper and lower surfaces of the current collector have different electrochemical stability. Thus, the electrochemical stability of the current collector can be controlled depending on the operating potential of the active material and the charge and discharge voltage. This enables a high-performance battery to be highly reliably produced. Such a two-layer current collector can also be used, for example, as a current collector for bipolar electrodes.

The shape and thickness of the current collector can be controlled as desired, for example, by controlling printing formation. The thickness of a single film can be controlled in a range of, for example, 0.1 μm to 10 μm. Film formation may be repeated to form a thick film. For example, the current collector may have a multilayer film structure in which thin films of different materials are laminated or a structure in which different materials are patterned on a surface. An example of the current collector having a multilayer film structure is a current collector having a two-layer structure including a layer of the first metal particles 111 and a layer of the second metal particles.

If the current collector has, for example, a rectangular pattern, the corners may be cut, or the corners may be rounded to eliminate sharp edges. This reduces defects such as cracking of the print pattern that starts from a portion where stress tends to be concentrated (e.g., around corners) during transfer of the print pattern.

The first and second current collectors 110 and 210 each may have a portion that is embedded in the solid electrolyte layer 300 by pressure applied to laminate them on the solid electrolyte layer 300. The current collector embedded as above has an outer peripheral side surface connected to the solid electrolyte layer 300, resulting in strong connection between the current collector and the solid electrolyte layer 300.

As the metallic material of the first metal particle 111, any known metallic material that can be used as the current collector can be used. Examples of the metallic material of the first metal particle 111 include copper, silver, nickel, aluminum, palladium, and gold. The metallic material may be an elemental metal or an alloy. As the metallic material of the second metal particle that can be included in the green compact, it is also possible to use any known metallic material that can be used as a current collector. Examples of the metallic material of the second metal particle include copper, silver, nickel, aluminum, palladium, and gold. The material of the metal particle used in the green compact forming the current collector may be selected appropriately so that the material does not melt and decompose in the production process, at the operating temperature, and under the operating pressure, and in view of the battery operating potential applied to the current collector and conductivity. The material of the current collector may also be selected according to the required tensile strength and heat resistance.

The first metal particle 111 may be a composite metal particle, which includes multiple metals that have different compositions. With this configuration, properties such as corrosion resistance, thermal expansion, electrochemical stability, and mechanical reliability of the current collector can be controlled. This enables a high-performance battery having high reliability to be produced. The second metal particle that can be included in the green compact may also be a composite metal particle, which includes multiple metals having different compositions, like the first metal particle 111.

The first metal particle 111 may be a composite metal particle, which includes multiple metals having different potentials. With this configuration, electrochemical stability of the current collector can be controlled. This enables a high-performance battery having high reliability to be produced. The second metal particle that can be included in the green compact may also be a composite metal particle, which includes multiple metals having different potentials, like the first metal particle 111.

The thickness of the current collector is, for example, greater than or equal to 0.3 μm and less than or equal to 5 μm. When the thickness of the current collector is increased, the electrical resistance of the current collector in the in-plane direction decreases, and thus the electrical resistance is improved. However, when the thickness of the current collector is increased, the thermal shock resistance decreases due to thermal expansion difference and weight energy density decrease, and thus thickness may be set appropriately in view of the overall design.

Next, the first protection layer 112 on at least a portion of the surface of the first metal particle 111 will be described in detail.

The first protection layer 112 covers at least a portion of the surface of the metal portion of the first metal particle 111 and includes an oxide.

The oxide in the first protection layer 112 may be, for example, an oxide of the metal component forming the first metal particle 111. With this configuration, the metal portion of the first metal particle 111 can be in tight and close contact with the oxide on the surface of the metal portion. Thus, the bondability between the surface of the metal portion of the first metal particle 111 and the first protection layer 112 is improved, allowing the highly stable first protection layer to be held on the surface of the first metal particle. This configuration can provide a battery having further improved reliability. Hereinafter, the surface of the metal portion of the first metal particle 111 may be referred to as the metal surface of the first metal particle 111.

The first protection layer 112 may be formed of a material that can improve the corrosion resistance of the metal particle to, for example, gases and oxidation. Oxides, especially metal oxides, which are generally more stable than metals, are suitable as a material of the first protection layer 112. The current collector can become hot during operation of the battery 1000. For this reason, an oxide-based material having high-temperature stability is suitable for the material of the first protection layer 112.

The first protection layer 112 may include a metal oxide containing at least one selected from the group consisting of Al, Zr, Ti, and Si. This configuration can further improve the corrosion resistance of the protection layer. Thus, the reliability of the current collector can be improved, and thus a battery having higher reliability can be produced.

The first protection layer 112 may include an oxide other than oxide of the metal component forming the first metal particle 111.

For example, the first protection layer 112 may include an inorganic glass oxide. For example, the first protection layer 112 may be formed of an inorganic glass oxide. The first protection layer 112 may further include an inorganic particle in addition to the inorganic glass oxide. When the first protection layer 112 including a glass component further includes an inorganic particle, which is a component having high stability and high mechanical strength, the stability and mechanical strength of the current collector can be further improved. Examples of such an inorganic particle material include alumina, zirconia, and silica.

The first protection layer 112 may include an amorphous material. The first protection layer 112 that includes an amorphous material is softer than one that is composed only of a crystalline material. Thus, the first protection layer 112 is more readily plastically deformed. This reduces friction and improves sliding between the particles during application of pressure to the first metal particles 111 in the formation of the green compact, improving the compactness of the green compact. This also makes it easier for the first protection layer 112 to be readily pushed and moved from the joint interface between the particles to the void in the green compact during the formation of the green compact. The void in the green compact is, for example, a space between the first metal particles 111 (e.g., void at the grain boundary triple point of the first metal particles 111). Thus, the component of the first protection layer 112 that fills the void can be increased, reducing the exposed surface of the first metal particle 111. The exposed surface of the first metal particle 111 means a surface that is not in contact with the material of the current collector, such as a surface facing the void in the green compact. The reduction in the exposed surface of the first metal particle 111 improves resistance of the current collector, and thus a battery having higher reliability can be produced.

The first protection layer 112 may include two or more oxides having different compositions. This configuration improves the corrosion resistance of the first protection layer 112 to multiple types of gases and other substances, improving the corrosion resistance of the current collector. Thus, a battery having further improved reliability can be produced.

The first protection layer 112 may be composed of a multilayer film having two or more layers. For example, the multilayer film includes thin films formed of different materials. This configuration improves the corrosion resistance of the first protection layer 112 to multiple types of gases and other substances, improving the corrosion resistance of the current collector. Thus, a battery having further improved reliability can be produced. When the first protection layer 112 is composed of a multilayer film, the frictional properties between the first metal particles 111 during application of pressure in the formation of the green compact can be varied. For example, a soft film may be positioned at the outermost surface of the multilayer film to reduce the friction between the first metal particle 111 and adjacent particles. This can improve the compactness of the green compact. This makes it possible to produce a low-resistance and highly reliable current collector, and thus a battery having further improved reliability can be produced. The multilayer film may include thin films formed of the same material.

When the green compact forming the current collector includes the second metal particles, each of the second metal particles may have a second protection layer on at least a portion of the surface. When the green compact includes the second metal particle having the second protection layer on its surface, the current collector can have higher reliability. Thus, a battery having further improved reliability can be produced. The material and configuration of the second protection layer are the same as those of the above-described first protection layer 112 and are not described in detail here.

The second protection layer may be formed of a material having a different composition than the material of the first protection layer 112. With this configuration, the first current collector 110 can further have corrosion resistance to components such as gas components that are different from those to which the first protection layer 112 has corrosion resistance. Thus, the first current collector 110 can have higher stability against various gas components, and thus a battery having further improved reliability can be produced.

The second protection layer may have a different thickness than the first protection layer 112. With this configuration, the first current collector 110 can further have corrosion resistance to components such as gas components that are different from those to which the first protection layer 112 has corrosion resistance over a wide range of conditions. Thus, a current collector can have higher stability against various gas components, and thus a battery having further improved reliability can be produced. Furthermore, the compactness of the green compact can be controlled by, for example, adjusting the deformability and frictional properties of the second protection layer as needed. This makes it possible to produce a low-resistance and highly reliable current collector, and thus a battery having further improved reliability can be produced.

Hereinafter, the first metal particle 111 and the second metal particle may be collectively and simply referred to as the “metal particle”. Furthermore, the first protection layer 112 and the second protection layer may be collectively and simply referred to as the “protection layer”.

The protection layer may have a thickness of, for example, greater than or equal to 1 nm and less than or equal to 50 nm. The larger the thickness of the protection layer, the larger the corrosion resistance of the current collector. However, if the thickness of the protection layer is too large, the protection layer may delaminate from the metal surface of the metal particle due to the thermal expansion difference. Thus, it is desirable to set the thickness of the protection layer to an appropriate thickness in view of the reliability against, for example, temperature cycling.

The first protection layer 112 and the second protection layer may have various combinations of thicknesses and materials. Specifically, the first protection layer 112 and the second protection layer may have different thicknesses, material compositions, or oxide compositions. This enables what the first protection layer 112 and the second protection layer have corrosion resistant against (e.g., against gas components) and durability to be controlled. Such control can further enhance the durability of the current collector.

The protection layer can be formed, for example, by exposing a particulate metal to an atmospheric or oxygen atmosphere and applying an appropriate heat treatment on it. The heat treatment may be performed at a temperature in the range of, for example, 25° C. to 500° C. for a time in the range of 1 minute to 1 hour, depending on the kind of the used metallic material and the particle diameter, for example.

If the protection layer includes an inorganic glass oxide, a liquid polymer, such as polysilazane, which is used as a glass coating agent, may be applied to or impregnated in a particulate metal and then dried and heat-treated so that the particulate metal is coated with the inorganic glass oxide. In this case, the thickness of the protection layer can be adjusted to any desired thickness in the range of, for example, 1 nm to 1 μm, by adjusting the dilution concentration using solvents such as xylene and toluene and the number of application repetitions of the liquid polymer. Another liquid polymer material may be additionally applied and dried to form a protection layer composed of a multilayer film including two or more layers having different compositions, for example. Furthermore, an inorganic particle may be mixed into a medium such as the above-described liquid polymer and solvent. This enables the protection layer including a glass component to have a layer structure having a highly stable and high mechanical strength component. Examples of the inorganic particle material include alumina, zirconia, and silica.

It is also possible to change the crystallinity of the protection layer by heat treatment after the liquid polymer is applied to or impregnated in the particulate metal. For example, a protection layer including an amorphous material can be formed by curing at a relatively low temperature (e.g., less than or equal to 300° C.), such as room temperature. For example, heat treatment at greater than or equal to 300° C. can also improve the crystallinity of the protection layer. Such control of the crystallinity of the protection layer results in adjustment of the hardness of the protection layer and adjustment of the bondability between the metal surface of the metal particle and the protection layer, and thus the compactness and reliability of the current collector can be controlled.

The protection layer may be formed by coating a particulate metal with a metal plating film by metal plating and then oxidizing the metal plating film by heat treatment. The thickness of the metal plating film is in a range of, for example, a few nm to about 1 μm.

The above methods of forming a protection layer can be used in combination to form a protection layer composed of a multilayer film including two or more layers having different compositions, for example. This enables thin films made of different materials (e.g., oxides) having different properties, such as different corrosion resistances and temperature cycling properties, to be multilayered. Thus, the reliability of the current collector can be further improved.

As described above, the protection layer including an amorphous material can be more readily plastically deformed. This reduces friction and improves sliding between the particles during application of pressure to the metal particles in the formation of the green compact, improving the compactness of the green compact. The protection layer that is readily plastically deformed tends to move into the void in the green compact (e.g., void at the grain boundary triple point) when the metal particle is pressurized to form the green compact. Thus, the void is filled with the protection layer at a high concentration with the conductivity between the metal particles being kept, improving both the conductivity and corrosion resistance of the current collector.

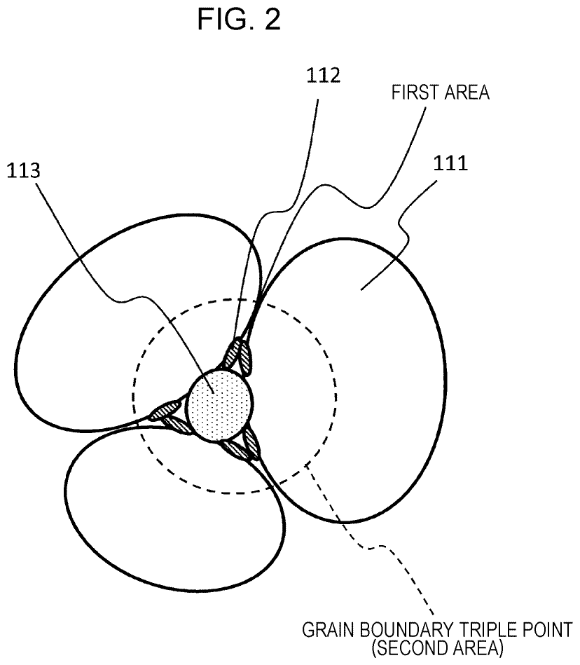

FIG. 2 is a magnified view of a portion around the grain boundary triple point of a green compact forming the current collector. As illustrated in FIG. 2, in the green compact, the first protection layer 112 may be moved to the void at the grain boundary triple point to be in the void. For example, the first protection layer 112 may have a larger volume in a second area, which is the void at the grain boundary triple point of the first metal particles 111, than in a first area, which is the joint interface between two adjacent first metal particles 111. This configuration can further improve the electrical connection at the joint interface between the first metal particles 111. Furthermore, since a large portion of the first protection layer 112 exists in the second area, which is the void at the grain boundary triple point of the first metal particles, a larger amount of the components of the first protection layer 112 can fill the void. This reduces the exposed surface area of the first metal particle 111. This enables a current collector that has less resistance loss and improved corrosion resistance to be produced, and thus a high-performance battery having improved reliability can be produced.

Furthermore, when the green compact includes the second metal particle, and the second metal particle has a smaller average particle diameter than the first metal particle, the second metal particle 113 is more likely to fill the void at the grain boundary triple point as illustrated in FIG. 2. Thus, in this case, a compact current collector can be produced.

The outermost surface of the first protection layer 112 desirably has low crystallinity to provide the above configuration where the first protection layer 112 is in the void at the grain boundary triple point as illustrated in FIG. 2. When the green compact includes the second metal particle 113, the first protection layer 112 and the second protection layer may have different crystallinity. This allows wide-range control of the compacting process relating to pressure, and thus a compact current collector that is more stable against the pressurization rate and pressurization temperature can be formed. The crystallinity of the protection layer can be lowered, for example, by repeated collisions between powders, which distort the atomic arrangement of the surface. For example, this may be done by using a widely-used powder processer such as a ball mill and a shaker. During the process, metal particles alone may be present in a container formed of, for example, polyethylene, a grinding medium such as a zirconia ball may be added as needed, or water or ethanol may be added. The collision energy can be adjusted by them.

The crystallinity and thickness of the protection layer can be determined, for example, by observation of the ion-milled cross section of the metal particle or green compact by using high-resolution TEM or SEM. For example, the crystallinity and thickness of the protection layer can be determined by observing the lattice image, the disordered atomic arrangement, and the physical thickness of the region by using high-resolution TEM or SEM. Like the hardness of the metal particle, the hardness of the protection layer can be evaluated and compared using a method such as a Micro Vickers hardness test by using the cross section of the current collector cut flat, for example, by ion milling.

The metal surface of the metal particle may be a rough surface, which increases the bonding area, to strengthen the green compact. This improves not only the bondability between the particles and the delamination resistance of the protection layer, but also the bondability between the current collector and the solid electrolyte layer 300, and bondability between the current collector and the first active material layer 120 or the second active material layer 220. In this case, the surface roughness of the metal surface of the metal particle may be, for example, in a range of Rz=0.1 μm to 1 μm. The rough surfaces of the metal particles can be formed by collisions between metal particles before the formation of the protection layer, or by processing the metal particles before the formation of the protection layer with a mixture of hard fine particles (e.g., SiC fine particles) having a particle diameter less than or equal to the target Rz value. The metal surfaces of the metal particles can also be roughened by impact and collision between the particles, for example, by using a particle composing machine such as “NOBILTA” available from HOSOKAWA MICRON CORPORATION, which can apply shear stress to the particles. The fine oxide particles having the composition as a protection layer may be processed in a particle composing machine to form a protection layer on the metal particle, simultaneously forming a rough surface. The first metal particle and the second metal particle may have different degrees of surface roughness. This allows the surfaces of the first metal particle and the second metal particle to have shapes adjusted depending on the mechanical properties, further improving the bondability of the composite metallic material including two types of metal particles. The rough surfaces of the first and second metal particles improve the interfacial bondability between the particles, enabling a battery having high reliability against expansion and contraction caused by temperature cycling and charge and discharge cycling to be produced.

The current collector may further include a resin component. This resin component may be, for example, a binder component to be added to the material including metal particles during formation of the green compact. This configuration enhances the mechanical strength of the current collector and bondability with the active material layer. Thus, a battery having high reliability against external stresses such as deflection or impact can be produced.

The current collector may include at least one selected from the group consisting of a Si-containing component and a F-containing component. The Si-containing component and the F-containing component may be, for example, a resin component. With this configuration, a current collector can have high heat resistance and high corrosion resistance. The flexibility of the Si-containing or F-containing component can absorb the difference in the thermal expansion coefficient of the joint interface between the Si-containing or F-containing component (e.g., resin component) and the metal particle, which may be caused by a rapid temperature change. Thus, the Si-containing or F-containing component is less likely to delaminate from the first current collector, and the current collector can keep high heat resistance and corrosion resistance. This makes it possible to produce a battery that has high reliability against heat generation in the battery due to high-rate operation such as rapid charging and discharging.

At least one selected from the group consisting of the Si-containing component and the F-containing component described above may be included in the current collector, for example, by adhesion of at least one selected from the group consisting of a silicone-based resin and a fluorine-based resin to the green compact. For example, in the formation of the green compact, a thin layer of silicone-based or fluorine-based resin formed as a release agent on a polyethylene terephthalate (PET) film or the like may be brought into contact with the green compact and pressurized, enabling the Si-containing component and the F-containing component to be transferred in a thickness of, for example, 5 nm to 10 nm, without affecting the electrical conductivity.

In a current collector including at least one selected from the group consisting of a Si-containing component and a F-containing component formed by the above method, for example, the total volume concentration of the Si-containing component and the F-containing component is higher at the interface between the current collector and the active material layer than in an inner portion of the current collector. This configuration increases the reliability of the interface between the current collector, which has the highest ion travel density and tends to generate heat, and the active material layer, enabling a battery having further improved reliability to be produced. The volume concentration of the Si-containing component and the F-containing component of the current collector can be determined, for example, by image analysis of the areas of the Si-containing component and the F-containing component in an image such as an SEM image of the cross section of the current collector. In other words, the area in the cross section of the current collector is considered as the volume to determine the volume concentration. The Si-containing component and the F-containing component can be distinguished from other components by the shading of the reflection electron image obtained by SEM or the surface analysis image obtained by elemental analysis such as SEM-EDS or EPMA. For the volume concentration of the Si-containing component and the F-containing component, for example, the interface between the current collector and the active material layer is defined as the surface area of the current collector, which extends from the interface between the current collector and the active material layer (i.e., the surface of the current collector) to the depth of 50 nm, and the area other than the surface area is defined as an inner portion of the current collector.

### Active Material Layer

The first active material layer 120 is, for example, a positive electrode active material layer. The first active material layer 120 is positioned between the first current collector 110 and the solid electrolyte layer 300. The first active material layer 120 may be in contact with the first current collector 110. The first active material layer 120 may be in contact with the solid electrolyte layer 300.

The second active material layer 220 is, for example, a negative electrode active material layer. The second active material layer 220 is positioned between the second current collector 210 and the solid electrolyte layer 300. The second active material layer 220 may be in contact with the second current collector 210. The second active material layer 220 may be in contact with the solid electrolyte layer 300.

The positive electrode active material layer includes a positive electrode active material.

A positive electrode active material is a substance in which metal ions, such as lithium (Li) ions and magnesium (Mg) ions, are inserted into or removed from the crystal structure at a higher potential than the negative electrode and is oxidized or reduced accordingly. The type of positive electrode active material is appropriately selected depending on the type of all-solid-state battery, and known positive electrode active materials may be used.

The positive electrode active material may be a compound including lithium and a transition metal element. Examples of the compound include an oxide that includes lithium and a transition metal element and a phosphate compound that includes lithium and a transition metal element.

Examples of the oxide that includes lithium and a transition metal element include lithium nickel composite oxides such as LiNiₓM₁₋ₓO₂ (where M is at least one selected from the group consisting of Co, Al, Mn, V, Cr, Mg, Ca, Ti, Zr, Nb, Mo, and W, and x satisfies 0<x≤1), layered oxides such as lithium cobalt oxide (LiCoO₂), and lithium nickel oxide (LiNiO₂), and lithium manganese oxides having a spinel structure (such as LiMn₂O₄, Li₂MnO₃, and LiMnO₂).

An example of the phosphate compound including lithium and a transition metal element is lithium iron phosphate (LiFePO₄) having an olivine structure.

As the positive electrode active material, sulfur(S) and sulfides such as lithium sulfide (Li₂S) may be used. In this case, lithium niobate (LiNbO₃) or the like may coat or may be added to the positive electrode active material particles.

As the positive electrode active material, one of the above materials may be solely used, or two or more of the above materials may be used in combination.

To improve lithium-ion conductivity or electronic conductivity, the positive electrode active material layer may contain a material other than the positive electrode active material, in addition to the positive electrode active material. In other words, the positive electrode active material layer may be a composite layer. Examples of such a material include solid electrolytes such as inorganic solid electrolytes and sulfide solid electrolytes, conductive aids such as acetylene black, and binders such as polyethylene oxide and polyvinylidene fluoride.

The positive electrode active material layer may have a thickness of, for example, greater than or equal to 5 μm and less than or equal to 100 μm.

The negative electrode active material layer includes the negative electrode active material.

The negative electrode active material layer is a layer composed mainly of a negative electrode material such as a negative electrode active material.

A negative electrode active material is a substance in which metal ions, such as lithium (Li) ions or magnesium (Mg) ions, are inserted into or removed from the crystal structure at a lower potential than the positive electrode and is oxidized or reduced accordingly. The type of negative electrode active material is appropriately selected depending on the type of battery, and known negative electrode active materials may be used.

Examples of the negative electrode active material include carbon materials such as natural graphite, artificial graphite, graphite carbon fiber, and resin heat-treated carbon, and alloy-base materials that form a composite material with the solid electrolyte. Examples of the alloy-base materials include lithium alloys such as LiAl, LiZn, Li₃Bi, Li₃Cd, Li₃Sb, Li₄Si, Li_{4.4}Pb, Li_{4.4}Sn, Li_{0.17}C, and LiC₆, oxides of lithium and a transition metal element such as lithium titanate (Li₄Ti₅O₁₂), and metal oxides such as zinc oxide (ZnO) and silicon oxide (SiOₓ).

As the negative electrode active material, one of the above materials may be solely used, or two or more of the above materials may be used in combination.

To improve the lithium-ion conductivity or the electron conductivity, the negative electrode active material layer may contain, in addition to the negative electrode active material, a material other than the negative electrode active material. Examples of such a material include solid electrolytes such as inorganic solid electrolytes and sulfide solid electrolytes, conductive aids such as acetylene black, and binders such as polyethylene oxide and polyvinylidene fluoride.

The negative electrode active material layer may have a thickness of, for example, greater than or equal to 5 μm and less than or equal to 100 μm.

As illustrated in FIG. 1(b), the active material layer is rectangular in plan view but should not be limited to this. The active material layer may be circular or oval, as long as it has a portion in contact with the current collector. The active material layer may be larger or smaller than the current collector in plan view.

### Solid Electrolyte Layer

The solid electrolyte layer 300 includes a solid electrolyte.

The solid electrolyte layer 300 includes, for example, a solid electrolyte as a main component. Herein, the main component means a component most abundant by mass in the solid electrolyte layer 300. The solid electrolyte layer 300 may only include a solid electrolyte material.

The solid electrolyte may be any known solid electrolyte for batteries that has ion conductivity. The solid electrolyte contained in the solid electrolyte layer 300 may be a solid electrolyte that conducts metal ions such as lithium ions and magnesium ions.

Examples of the solid electrolyte include sulfide solid electrolytes, oxide solid electrolytes, and halide solid electrolytes.

Examples of the sulfide solid electrolytes include Li₂S—P₂S₅ solid electrolytes, Li₂S—SiS₂ solid electrolytes, Li₂S—B₂S₃ solid electrolytes, Li₂S—GeS₂ solid electrolytes, Li₂S—SiS₂—LiI solid electrolytes, Li₂S—SiS₂—Li₃PO₄ solid electrolytes, Li₂S—Ge₂S₂ solid electrolytes, Li₂S—GeS₂—P₂S₅ solid electrolytes, and Li₂S—GeS₂—ZnS solid electrolytes.

Examples of the oxide solid electrolytes include lithium-containing metal oxides, lithium-containing metal nitrides, lithium phosphate (Li₃PO₄), and lithium-containing transition metal oxides. Examples of the lithium-containing metal oxides include Li₂O—SiO₂ and Li₂O—SiO₂—P₂O₅. An example of lithium-containing metal nitrides is LiₓPyO_{1-z}N_{z} (0<z≤1). An example of the lithium-containing transition metal oxide is lithium titanium oxide.

An example of the halide solid electrolytes is a compound including Li, M, and X. Here, M is at least one selected from the group consisting of metallic elements other than Li and metalloid elements. X is at least one selected from the group consisting of F, Cl, Br, and I.

The “metalloid elements” include B, Si, Ge, As, Sb, and Te. The “metallic elements” are all elements in Groups 1 to 12 of the periodic table (except hydrogen) and all elements in Groups 13 to 16 of the periodic table (except B, Si, Ge, As, Sb, Te, C, N, P, O, S, and Se).

To improve the ion conductivity of the halide solid electrolyte, M may include Y. M may be Y.

The halide solid electrolyte may be, for example, a compound represented by LiₐMe_{b}Y_{c}X₆. Here, a+mb+3c=6 and c>0 are satisfied. The value of m represents the valence of Me.

To improve the ion conductivity of halide solid electrolytes, Me may be at least one selected from the group consisting of Mg, Ca, Sr, Ba, Zn, Sc, Al, Ga, Bi, Zr, Hf, Ti, Sn, Ta, and Nb.

To improve the ion conductivity of the halide solid electrolyte, X may include at least one selected from the group consisting of Cl and Br.

The halide solid electrolyte may include at least one selected from the group consisting of Li₃YCl₆ and Li₃YBr₆.

As a solid electrolyte, one of these materials may be solely used, or two or more of these materials may be used in combination.

The solid electrolyte layer 300 may include a binder such as polyethylene oxide and polyvinylidene fluoride in addition to the solid electrolyte.

The solid electrolyte layer 300 may have a thickness of, for example, greater than or equal to 5 μm and less than or equal to 150 μm.

The material of the solid electrolyte may be composed of an aggregate of particles. Alternatively, the material of the solid electrolyte may have a sintered structure.

The battery 1000 according to the first embodiment includes the first current collector 110 having the above-described configuration, enabling the current collector having a pattern difficult for a current collector formed of a metal foil to have to be highly reliably formed. This allows the battery 1000 according to the first embodiment to form various types of battery assemblies, such as a large-capacity battery in which batteries are connected in parallel or in series by a laminating process.

The following differences are found between the configuration of the battery 1000 according to the first embodiment and the configuration of the battery described in Japanese Unexamined Patent Application Publication No. 2009-193802.

Japanese Unexamined Patent Application Publication No. 2009-193802 discloses a battery including a green compact created by compacting a conductive current collector forming powder. However, the current collector formed of the metal particle not having the above-described protection layer has low corrosion resistance to gases or moisture, leading to surface modification for example, oxidation and sulfidation of the particle. Thus, conductivity between the particles is reduced at the particle interface. Furthermore, at the particle interface, stress is caused by expansion of the modified surface layer, making the particle brittle and reducing the mechanical strength. The expansion of the modified surface layer includes volume expansion caused by oxidation or sulfidation. As described above, the battery described in Japanese Unexamined Patent Application Publication No. 2009-193802 has a problem of insufficient reliability of the current collector. In contrast, the battery 1000 according to the first embodiment includes the current collector formed of the green compact having high corrosion resistance because of the metal particle having the protection layer on the surface. Thus, the battery 1000 according to the first embodiment has less decrease in conductivity and mechanical strength, resulting in high reliability.

### Second Embodiment

Hereinafter, a battery according to a second embodiment will be described. Description of the features described in the above first embodiment will not be described where appropriate.

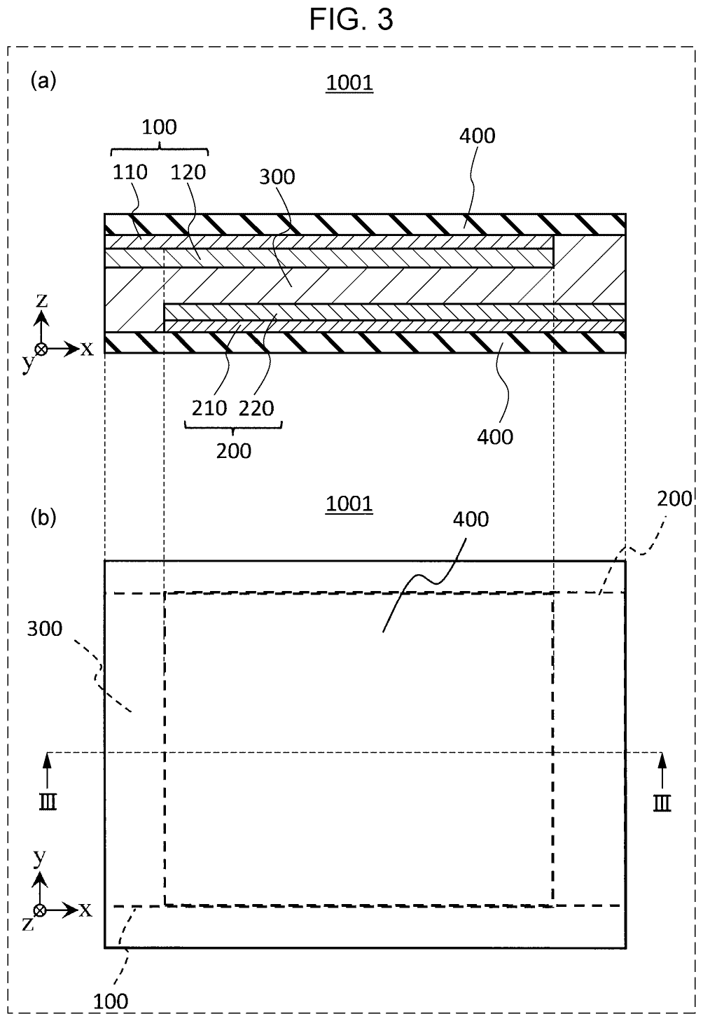

FIG. 3 illustrates a cross-sectional view and a plan view each illustrating a schematic configuration of a battery 1001 according to the second embodiment.

FIG. 3(a) is a cross-sectional view of the battery 1001 according to the second embodiment. FIG. 3(b) is a plan view of the battery 1001 according to the second embodiment viewed from below in the z direction. FIG. 3(a) illustrates a cross section taken along a dotted line III-III in FIG. 3(b).

As illustrated in FIG. 3, the battery 1001 further includes a cover layer 400 in addition to the components of the battery 1000 according to the first embodiment.

The cover layer 400 serves as a protection layer that protects the battery element of the battery 1001 from impact and the environment. This can further improve the reliability of the battery 1001.

The cover layer 400 may be formed, for example, of a green compact. When the cover layer 400 is formed of a green compact, the particles on the surface act as an anchor and provide a high degree of bondability with the current collector formed of a green compact. Furthermore, with this configuration, force acting on the interface between the cover layer 400 and the current collector are readily dispersed. Thus, this configuration can reduce interfacial delamination between the cover layer 400 and the current collector.

The cover layer 400 is provided on at least one of the first electrode 100 or the second electrode 200.

As illustrated in FIG. 3, the cover layer 400 may be disposed on each of the first electrode 100 and the second electrode 200.

The cover layer 400 may be formed of a solid electrolyte material. The cover layer 400 may include, for example, a solid electrolyte forming the solid electrolyte layer 300. The cover layer 400 including the same material as the battery element can have a coefficient of thermal expansion close to that of the battery element. This improves the durability of the battery 1001 against, for example, heat treatment in the production process of the battery 1001, environmental temperature changes during use of the battery 1001, and temperature cycling.

The cover layer 400 may include a different material than materials forming the battery element.

The cover layer 400 may be formed of an insulating material. Examples of the insulating material include an inorganic ceramic material and a resin material. Examples of the inorganic ceramic material include aluminum oxide and boron nitride. An example of the resin material is epoxy resin. When the cover layer 400 includes aluminum oxide or boron nitride, which has high thermal conductivity, thermal expansion difference in the battery element has less influence even if the battery 1001 is made larger. Thus, the battery 1001 can have high thermal shock resistance. Epoxy resins are lightweight. Thus, when the cover layer 400 includes epoxy resin, a decrease in the gravimetric energy density of the battery 1001 is reduced. The resin material is typically softer than the components of the battery element of the battery 1001. The cushioning properties of the resin material improves shock resistance of the battery 1001.

If the cover layer 400 is provided on each of the first electrode 100 and the second electrode 200, the cover layers 400 may have the same thickness. This allows the battery 1001 to have less structural defects such as warpage and cracks because the stress is uniformly applied to the upper and lower cover layers 400 during compression caused when pressure is applied by laminating or during shrinkage caused by heat treatment in the process of producing the battery 1001.

The thickness of the cover layer 400 is, for example, greater than or equal to 100 μm and less than or equal to 500 μm.

The cover layer 400 can be formed, for example, by pressure-transferring a precursor of the cover layer 400, which is a slurry including the material of the cover layer 400 on a PET film, to the surface of the current collector. The precursor of the cover layer 400 formed by coating a slurry including the material of the cover layer 400 corresponds to a compact, which is called a green sheet in the technical field of multilayer ceramic capacitors (MLCC), for example. For example, a silicone resin is applied on the surface of a PET film in advance, and then a slurry including a material of the cover layer 400, such as a solid electrolyte slurry, is applied. The thickness of the silicone resin applied to the surface of the PET film is, for example, greater than or equal to 10 nm and less than or equal to 50 nm. In this case, the silicone resin component remains on the surface of the precursor of the cover layer 400 transferred onto the current collector (i.e., the surface delaminated from the PET film). Thus, the surface of the current collector including the plating film is covered with the cover layer 400 including a silicone resin component. The silicone resin component, which is chemically stable, provides corrosion protection to the surface of the current collector in contact with the silicone resin component.

The silicone-based resin component can be detected, for example, as an area having a higher silicon (Si) concentration than other areas, when the ion-polished cross section is analyzed by a compositional analysis technique such as electron probe micro-analyzer (EPMA).

Alternatively, the cover layer 400 may be formed by printing a slurry including the material of the cover layer 400 onto the current collector, for example, using a metal mask or screen plate.

Markers may be printed on the cover layer 400 to indicate polarity, such as positive and negative. The shape of the marker is not limited. For example, a round or rectangular marker may be printed. Alternatively, the cover layer 400 may have a hole that is used as a marker. This makes it possible to identify the positive and negative electrodes of a battery from the appearance.

The cover layer 400 may include a pigment that allows the positive electrode and the negative electrode to be identified.

### Third Embodiment

Hereinafter, a battery according to a third embodiment will be described. Description of the features described in the above embodiments will not be described where appropriate.

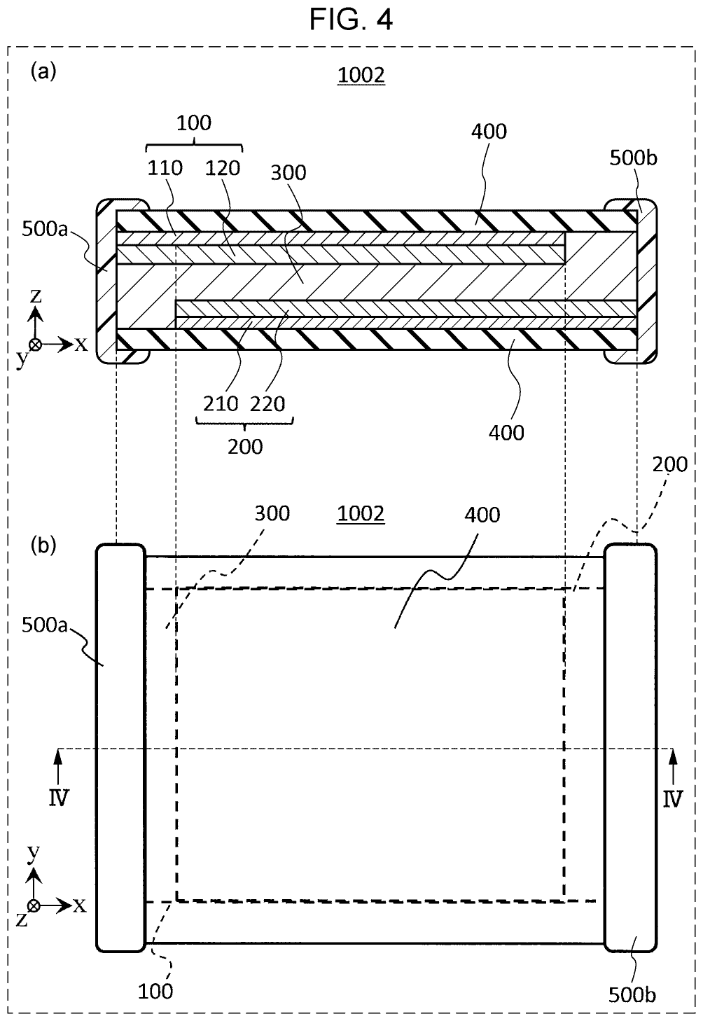

FIG. 4 illustrates a cross-sectional view and a plan view each illustrating a schematic configuration of a battery 1002 according to the third embodiment.

FIG. 4(a) is a cross-sectional view of the battery 1002 according to the third embodiment. FIG. 4(b) is a plan view of the battery 1002 according to the third embodiment viewed from below in the z direction. FIG. 4(a) illustrates a cross section taken along line IV-IV in FIG. 4(b).

The battery 1002 further includes terminal electrodes 500a and 500b in addition to the components of the battery 1001 according to the second embodiment. The terminal electrode 500a is electrically coupled to the first electrode 100. Specifically, the terminal electrode 500a is electrically coupled to the first current collector 110. The terminal electrode 500b is electrically coupled to the second electrode 200. Specifically, the terminal electrode 500b is electrically coupled to the second current collector 210. Hereinafter, the terminal electrode 500a and the terminal electrode 500b may be collectively and simply referred to as a “terminal electrode”.

The terminal electrode includes, for example, a metal conductor. Examples of the metal conductor include Ag and Cu. Ag and Cu, which have high conductivity, can reduce the resistance loss of the battery 1002.

The terminal electrode may be formed of a material including metal powder such as a conductive resin and a resin. Examples of the metal powder include Ag and Cu, which are listed above as examples of a metal conductor. Such terminal electrode makes it possible to produce a small and high-performance surface-mounted battery.

The surface of the terminal electrode may be plated. In other words, the battery 1002 according to the third embodiment may have a plating film on the surface of the terminal electrode. The plating film on the surface of the terminal electrode enables a strong and low-resistance connection with a mounting board. In addition, the plating film can reduce the possibility that moisture and gases, which may degrade the battery, will permeate into the battery element, improving the reliability of the battery. Thus, a small and high-performance surface-mounted battery can be produced. The surface of the terminal electrode is plated with a highly solder-wettable metal such as Sn, for example, by electrolytic plating. This enables solder mounting using a general-purpose reflow process. The thickness of the plating film on the surface of the terminal electrode is, for example, greater than or equal to 1 μm and less than or equal to 5 μm.

### Fourth Embodiment

Hereinafter, a battery according to a fourth embodiment will be described. Description of the features described in the above embodiments will not be described where appropriate.

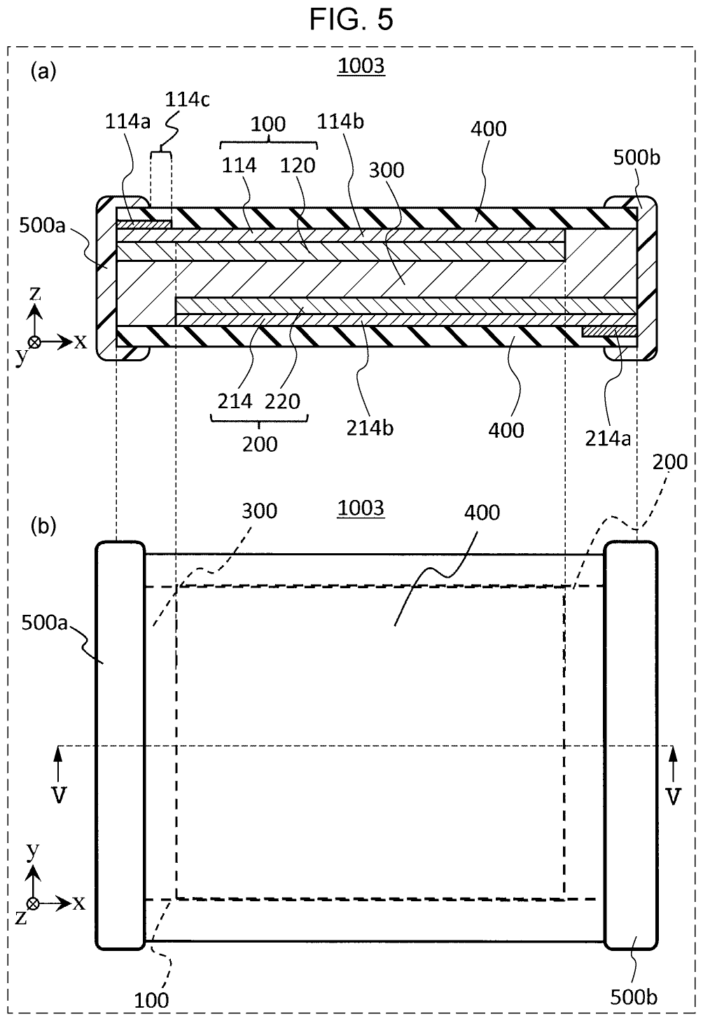

FIG. 5 illustrates a cross-sectional view and a plan view each illustrating a schematic configuration of a battery 1003 according to the fourth embodiment.

FIG. 5(a) is a cross-sectional view of the battery 1003 according to the fourth embodiment. FIG. 5(b) is a plan view of the battery 1003 according to the fourth embodiment viewed from below in the z direction. FIG. 5(a) illustrates a cross section taken along line V-V in FIG. 5(b).

The battery 1003 is different from the battery 1002 according to the third embodiment in the shape of the first and second current collectors. As illustrated in FIG. 5, the first current collector 114 has a larger thickness in plan view at an outer peripheral portion 114a than at a middle portion 114b. This increases the connection area when the terminal electrode 500a and the outer peripheral portion 114a of the first current collector 114 are connected. Thus, the connection resistance between the first current collector 114 and the terminal electrode 500a can be reduced. Furthermore, the adherence between the first current collector 114 and the terminal electrode 500a is improved. The first current collector 114 having such a configuration can be produced, for example, by using a green compact that has a larger thickness at a portion corresponding to the outer peripheral portion 114a than at a portion corresponding to the middle portion 114b. The use of the green compact having such a thickness reduces the possibility that the printed film will crack from the outer peripheral portion during the handling process such as transfer of the printed film of the current collector. Thus, defects in the first current collector 114 can also be reduced. Thus, a high-performance battery 1003 having high reliability can be produced.

The first current collector 114 may have a larger thickness at a portion near the portion connected to the terminal electrode 500a than at the other portions. This enhances the connection between the first current collector 114 and the terminal electrode 500a, improving reliability against deflection stress. In addition, the connection resistance between the first current collector 114 and the terminal electrode 500a can be further reduced.

For example, the first current collector 114 may have a portion that is about two times thicker than the middle portion 114b, and the portion may extend from the edge of the portion connected to the terminal electrode 500a over a width of 100 μm.

Like the first current collector 114, the second current collector 214 may have a larger thickness in plan view at the outer peripheral portion 214a than at the middle portion 214b. The second current collector 214 may have a larger thickness at a portion near the portion connected to the terminal electrode 500b than at the other portions.

Hereinafter, the outer peripheral portion of the current collector that is thicker than the middle portion is referred to as a thick portion.

The thick portion of the first current collector 114 and the thick portion of the second current collector 214 may be formed of different materials. The material of the thick portion of the current collector only has to be conductive. The material is desirably one that can be readily electrically connected to the terminal electrode. Examples of the material of the thick portion of the current collector include Au, Ag, Cu, Al, Ni, Fe, Pd, and Pt. Two or more of these conductive materials may be used in combination or in the form of an alloy. This enables the thermal expansion coefficient or mechanical properties of the current collector to be adjusted, improving thermal shock resistance or mechanical reliability of the current collector.

The thick portion may have a larger width than, for example, the portion of the terminal electrode 500a that is on the main surface of the battery 1003. This allows the stress load concentrated near the terminal electrode during bending to be dispersed over a protruding portion of the thick portion and reduced. This reduces the possibility that the terminal electrode 500a will crack at the end of the portion on the main surface of the battery 1003. The protruding portion of the thick portion of the first current collector 114 is, for example, the portion indicated by the reference sign 114c in FIG. 5(a). In other words, the protruding portion is a portion of the thick portion that is located inwardly from the end portion of the terminal electrode 500a that is on the main surface of the battery 1003.

The thick portion of the current collector may be formed by printing a paste for forming a current collector including the first metal particle partially thick. The thick portion may be formed by repeatedly printing a paste for forming a current collector including the first metal particle. When the thick portion is formed by such repeated printing, the film can be made thick while causing less stress during film formation, reducing delamination from the active material layer and warpage of the current collector. The current collector formed by repeated printing can be detected as a layered stripe pattern by cross-section observation using a detector such as SEM.

The thick portion of the current collector may have a thickness of greater than or equal to 10 μm.

The above configuration can reduce the connection resistance between the current collector and the terminal electrode, enabling a battery having even less resistance loss to be produced.

### Fifth Embodiment

Hereinafter, a battery according to a fifth embodiment will be described. Description of the features described in the above embodiments will not be described where appropriate.

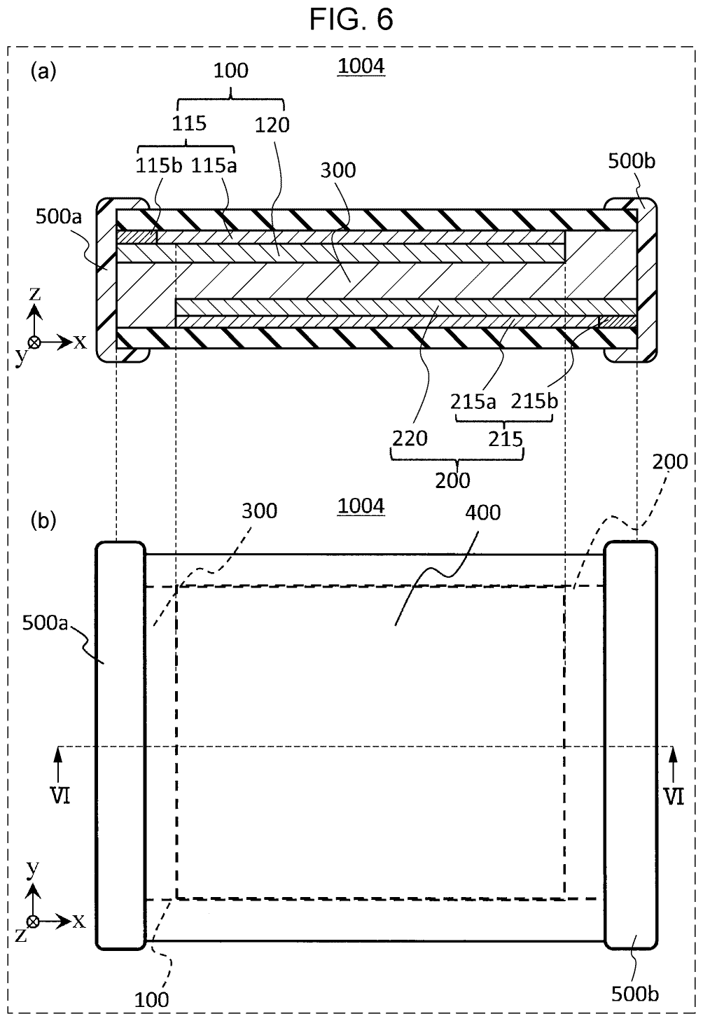

FIG. 6 illustrates a cross-sectional view and a plan view each illustrating a schematic configuration of a battery 1004 according to the fifth embodiment.

FIG. 6(a) is a cross-sectional view of the battery 1004 according to the fifth embodiment. FIG. 6(b) is a plan view of the battery 1004 according to the fifth embodiment viewed from below in the z direction. FIG. 6(a) illustrates a cross section taken along line VI-VI in FIG. 6(b).

As illustrated in FIG. 6, the battery 1004 has the same configuration as the battery 1002 according to the third embodiment except that a first current collector 115 includes portions formed of different materials arranged in a pattern on the same surface. In the battery 1004 according to the fifth embodiment, the first current collector 115 includes a portion 115a formed of a green compact including the first metal particle and a portion 115b formed of a green compact including the second metal particle. The portion 115b, which is formed of the green compact including the second metal particle, forms a portion of the first current collector 110 that is connected to the terminal electrode 500a. The portion 115a, which is formed of the green compact including the first metal particle, forms the portion other than the connected portion.

In the battery 1004 according to the fifth embodiment, the first metal particle may be formed of Ag, and the second metal particle may be formed of Pd. Since the connected portion is formed of a green compact including Pd particles, an alloy (e.g., Ag—Pd alloy) is formed around the connected portion by heat treatment in the formation of the terminal electrode 500a including Ag. Thus, an alloy bonding layer is formed at the connected portion between the first current collector 115 and the terminal electrode 500a, resulting in a strong and low-resistance connection between the first current collector 115 and the terminal electrode 500a. As described above, the metallic material of the second metal particle used in the connected portion may be a metal that forms an alloy with the terminal electrode. The heat treatment to generate the alloy may be performed in a belt furnace or general heat treatment furnace or performed by using a local high-temperature soldering iron or an iron, which heats only the connected portion.

The above configuration enables the connected portion of the first current collector 115 and the terminal electrode 500a to remain strongly fixed to each other against temperature cycling and impact, and thus low resistance between the first current collector 115 and the terminal electrode 500a can be maintained. This enables a high-performance battery 1004 having high reliability to be produced.

Like the first current collector 115, the second current collector 215 may also include portions formed of different materials arranged in a pattern on the same surface. For example, the portion of the second current collector 215 connected to the terminal electrode 500b (the area indicated by the reference sign 215b in FIG. 6) may be a green compact including the second metal particle, and the portion other than the connected portion (the area indicated by the reference sign 215a in the FIG. 6) may be a green compact including the first metal particle.

### Sixth Embodiment

Hereinafter, a battery according to a sixth embodiment will be described. Description of the features described in the above embodiments will not be described where appropriate.

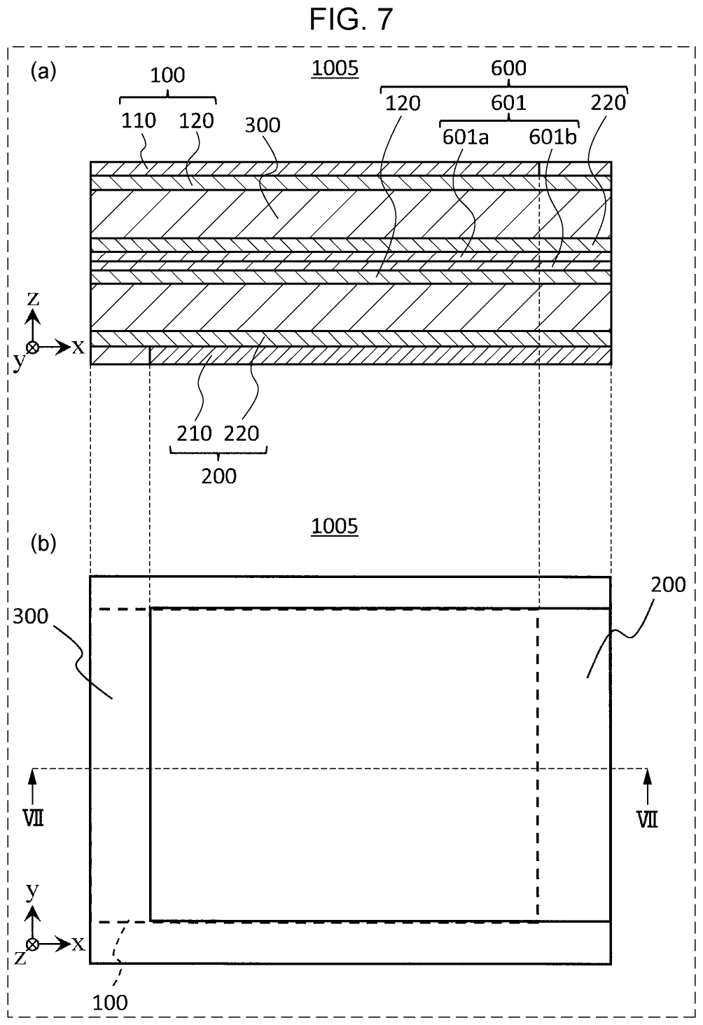

FIG. 7 illustrates a cross-sectional view and a plan view each illustrating a schematic configuration of a battery 1005 according to the sixth embodiment.

FIG. 7(a) is a cross-sectional view of the battery 1005 according to the sixth embodiment. FIG. 7(b) is a plan view of the battery 1005 according to the sixth embodiment viewed from below in the z direction. FIG. 7(a) illustrates a cross section taken along line VI-VI in FIG. 7(b).

As illustrated in FIG. 7, the battery 1005 has a structure in which multiple battery elements (i.e., single cells) are laminated on top of another. The single cells may be connected in series.

The battery 1005 has, for example, a bipolar electrode 600 that connects the single cells.

The current collector 601 of the bipolar electrode 600 is composed of two layers of green compacts having different compositions. Specifically, for example, the current collector 601 includes a layer 601a formed of a green compact including a first metal particle and a layer 601b formed of a green compact including a second metal particle. The above-described two-layer structure, which includes a layer of the first metal particle and a layer of the second metal particle, allows the upper surface and the lower surface of the current collector 601 to have different electrochemical stability. For example, the current collector 601 can be formed by transferring printed films formed by performing printing formation twice so that the metal of the metal particle on the positive electrode side is Al and that on the negative electrode side is Ni. The current collector 601 may be formed by transferring and laminating two types of printed films formed separately.

The printing method is not limited. For example, screen printing may be used to print a paste containing Al particles having a protection layer and a paste containing Ni particles having a protection layer. Two types of pastes that are formed separately may be each printed on a PET film coated with a silicone-based or fluorine-based resin release agent having a thickness of, for example, 10 nm to 50 nm and may be pressure-transferred to form the current collector. This further improves the corrosion resistance of the current collector because the Si-containing or F-containing component can also be transferred to be included in the current collector.

The multilayered current collector having two layers of different green compacts joined together on the front and back can form the bipolar electrode 600 having an electrochemically stable combination. In the bipolar electrode 600 having such a configuration, the layers 601a and 601b are joined by the particles forming the respective green compacts, and thus the bonding reliability is increased and the connection resistance between the two layers formed of different metals is reduced. For a multilayered current collector, the thickness and the material composition of each layer may be set to any thickness and any composition in view of electrochemical stability, mechanical strength, and heat resistance. The layers of the green compacts may have the same composition but different particle shapes. This allows the bondability between the layer of the green compact and the adjoining active material layer and the resistance loss at the joint interface to be controlled. With this configuration, a low-resistance and highly reliable bipolar electrode can be produced, and thus a series-connected multilayer battery having high performance and high reliability can be produced.

### Method of Producing Battery

Next, an example of a method of producing a battery according to the embodiment will be described. Hereinafter, a method of producing the battery 1000 according to the first embodiment will be described.

In the following example, the first electrode 100 is a positive electrode, and the second electrode 200 is a negative electrode.

First, pastes for print-forming the positive electrode active material layer and the negative electrode active material layer are prepared. For example, a glass powder of Li₂S—P₂S₅ sulfide, which has an average particle diameter of about 1 μm and is mainly composed of triclinic crystals, is provided as a solid electrolyte forming a composite material for the positive electrode active material layer and the negative electrode active material layer. The glass powder has ion conductivity of, for example, 3×10⁻³ S/cm to 4×10⁻³ S/cm.

The positive electrode active material may be a powder of layered Li—Ni—Co—Al composite oxide (LiNi_{0.8}Co_{0.15}Al_{0.05}O₂) having an average particle diameter of about 2 μm.

A composite material containing the above positive electrode active material and the above glass powder is dispersed in an organic solvent or the like to produce a paste for the positive electrode active material layer.

The dispersion of the composite material containing the above-described glass powder into an organic solvent or the like forms a slurry for the solid electrolyte layer used to form the solid electrolyte layer.

The negative electrode active material may be a natural graphite powder having an average particle diameter of about 3 μm. A composite material containing the above negative electrode active material and the above glass powder is dispersed in an organic solvent or the like to produce a paste for the negative electrode active material layer.

Next, an Al particle having a protection layer on its surface and a Ni particle having a protection layer on its surface, for example, are prepared as the materials used as the positive and negative electrode current collectors, respectively. The average particle diameter of the Al particle is, for example, 1.0 μm. The average particle diameter of the Ni particle is, for example, 0.3 μm. The protection layer can be formed by a SiO₂-based glass (amorphous) in advance, for example, by spraying polysilazane onto the metal conductive particle powder using a two-fluid nozzle while the metal particles are vibrated and dried at about 100° C. The thickness of the protection layer formed in this way is within a range of, for example, 1 nm to 10 nm. Pastes for positive and negative electrode current collectors are prepared by dispersing a positive electrode current collector material and a negative electrode current collector material each including a metal particle having the protection layer on its surface, together with a binder component, in an organic solvent or the like.

A solid electrolyte layer sheet is formed by using a slurry for a solid electrolyte layer. The slurry for a solid electrolyte layer is formed into a sheet having a thickness of about 10 μm to less than or equal to 50 μm by, for example, a die coater. The formed sheets may be multilayered. The paste for the positive electrode active material layer and the paste for the negative electrode active material layer are applied onto front and back surfaces of the above-formed sheet for a solid electrolyte layer to be in a predetermined shape and to have a thickness of about 50 μm to 100 μm. The pastes for the positive electrode active material layer and the negative electrode active material layer are dried by blowing air at 80° C. to 130° C. to have a thickness of 30 μm to 60 μm.

The paste for the positive electrode current collector and the paste for the negative electrode current collector are printed in a predetermined pattern on PET films having a thickness of, for example, 10 nm to 30 nm, which have been previously coated with silicone-based resin, to form the positive electrode current collector and the negative electrode current collector. Next, the positive electrode current collector and the negative electrode current collector formed by printing on the PET film are heated and pressurized to be delaminated from the PET film, and the respective current collectors are transferred on the dried patterns of the paste for the positive electrode active material layer and the paste for the negative electrode active material layer. The silicone-based resin component adheres to the surface of the current collector during transfer and functions as an anti-corrosion agent for the current collector. The current collector has a rough surface having a surface roughness of, for example, Rz=1 μm to 5 μm, and the rough surface enhances bondability with the solid electrolyte layer and the active material layer. In this way, a laminate sequentially including the positive electrode as the first electrode, the solid electrolyte layer, and the negative electrode as the second electrode is produced.

Next, the laminate is pressed with a pressure equivalent to 1 t/cm² to 3 t/cm², for example, at about 70° C. to form a laminate of the battery 1000. In addition, the laminate may be heated, heat-treated for sintering, or isostatically pressed as needed to increase the density in order to improve the strength and the properties.

Although the method of producing individual battery elements is described here, printed patterns (current collectors) of multiple battery elements may be transferred onto a solid electrolyte layer and cut into multiple batteries.

### Other Embodiments (Appendix)

The above description of embodiments discloses the following techniques.

### Technique 1

A battery includes:
a first electrode;
a second electrode; and
an electrolyte, wherein
the first electrode includes a first current collector and a first active material layer,
the first current collector is formed of a green compact including first metal particles,
the first metal particles each have a first protection layer on at least a portion of a surface of the first metal particle, and
the first protection layer includes an oxide.

In the battery according to the Technique 1, the first current collector of the first electrode is formed of a green compact including the first metal particles, and the first metal particles each have a first protection layer including an oxide on at least a portion of a surface of the first metal particle. This configuration enables the first current collector, which is a current collector formed by compacting a powder, to have higher corrosion resistance to, for example, gas components and solvents, resulting in improvement of the reliability of the current collector. This enables the battery according to the Technique 1, which is a battery having a current collector formed by compacting a powder, to have improved reliability. Furthermore, the first current collector, which is formed of a green compact, is less damaged in handling and less warped even when made thin than a current collector formed of a thin metal foil or the like. Thus, the first current collector has higher reliability than a current collector formed of a thin metal foil or the like and can be thinner. Thus, the battery according to Technique 1 can have a smaller size, a larger capacity, and a higher energy density. As above, the battery according to Technique 1 can have high reliability and further can have a smaller thickness, a larger capacity, and a higher energy density.

### Technique 2

The battery according to Technique 1, wherein the first protection layer includes an oxide of the metal component forming the first metal particle.

In this configuration, the metal portion of the first metal particle is in tight and close contact with the oxide on the surface of the metal portion. Thus, the bondability between the metal portion of the first metal particle and the first protection layer on the surface is improved. The first protection layer having high stability is held on the surface of the first metal particle. This configuration can provide a battery having further improved reliability.

### Technique 3

The battery according to Technique 1 or 2, wherein the first protection layer includes a metal oxide containing at least one selected from the group consisting of Al, Zr, Ti, and Si.

This configuration can further improve the corrosion resistance of the first protection layer. Thus, a battery having further improved reliability can be produced.

### Technique 4

The battery according to any one of Techniques 1 to 3, wherein the first protection layer includes an amorphous material.

The first protection layer having this configuration is softer than one that is composed only of a crystalline material. Thus, the first protection layer is more readily plastically deformed. This reduces friction and improves sliding between the particles during application of pressure to the first metal particles for formation of the green compact, improving the compactness of the green compact. This also makes it easier for the first protection layer to be readily pushed and moved from the joint interface between the particles to the void in the green compact during the formation of the green compact. Thus, a larger amount of the component of the first protection layer can fill the void, reducing the exposed surface of the first metal particle. Thus, the first current collector can be more resistant to corrosion, and thus a battery having higher reliability can be produced.

### Technique 5

The battery according to any one of Techniques 1 to 4, wherein first protection layer includes two or more oxides having different compositions from each other.

This configuration improves the corrosion resistance of the first protection layer to multiple types of gases and other substances, and thus a battery having further improved reliability can be produced.

### Technique 6

The battery according to any one of Technique 1 to 5, wherein the first protection layer is composed of a multilayer film having two or more layers.

This configuration improves the corrosion resistance of the first protection layer to multiple types of gases and other substances, and thus a battery having further improved reliability can be produced. Furthermore, the frictional properties between the first metal particles during application of pressure to form the green compact can be varied. For example, a soft film may be formed on the outermost surface to reduce friction. This can improve the compactness of the green compact. This makes it possible to produce a low-resistance and highly reliable first current collector, and thus a battery having further improved reliability can be produced.

### Technique 7

The battery according to any one of Techniques 1 to 6, wherein, in the green compact, the first protection layer has a larger volume in a second area that is a void at a grain boundary triple point of the first metal particles than in a first area that is a joint interface between adjacent two of the first metal particles.

This configuration further improves the electrical connection at the joint interface between the first metal particles. Furthermore, since a large portion of the first protection layers exists in the second area, which is the void at the grain boundary triple point of the first metal particles, a larger amount of the components of the first protection layer can fill the void. This reduces the exposed surface area of the first metal particle. This enables a first current collector that has less resistance loss and improved corrosion resistance to be produced, and thus a high-performance battery having improved reliability can be produced.

### Technique 8

The battery according to any one of Techniques 1 to 7, wherein the green compact further includes second metal particles, and the second metal particles include a metal different from a metal forming the first metal particles.

This configuration enables the properties of the first current collector to be controlled in various ways. For example, the presence of the second metal particles enables the first current collector to have properties that cannot be provided by a metallic material having a single composition, such as mechanical properties, electrochemical properties, and thermal expansion coefficient.

### Technique 9

The battery according to Technique 8, wherein the second metal particles have a smaller average particle diameter than the first metal particles.

This configuration allows the second metal particles to readily fill the voids between the first metal particles, and thus a compact first current collector, which includes a composite metallic material including the first metal particles and the second metal particles, can be produced. This enables a first current collector that has less resistance loss to be produced, and thus a higher-performance battery can be produced.

### Technique 10

The battery according to Technique 8 or 9, wherein the second metal particles each have a second protection layer on at least a portion of a surface of the second metal particle.

With this configuration, the first current collector can have further high reliability, and thus a battery having further improved reliability can be produced.

### Technique 11

The battery according to Technique 10, wherein the second protection layer is formed of a material having a different composition from a material of the first protection layer.

This configuration can further provide the first current collector with corrosion resistance to components such as gas components that are different from those to which the first protection layer has corrosion resistance. Thus, a first current collector having higher stability against various gas components can be produced, and thus a battery having further improved reliability can be produced.

### Technique 12

The battery according to Technique 10 or 11, wherein the second protection layer has a different thickness than the first protection layer.

This configuration can further provide the first current collector with corrosion resistance to components such as gas components that are different from those to which the first protection layer has corrosion resistance over a wide range of conditions. Thus, a first current collector having higher stability against various gas components can be produced, and thus a battery having further improved reliability can be produced. Furthermore, the compactness of the green compact can be controlled by, for example, adjusting the deformability and frictional properties of the second protection layer as needed. This makes it possible to produce a low-resistance and highly reliable first current collector, and thus a battery having further improved reliability can be produced.

### Technique 13

The battery according to any one of Techniques 8 to 12, wherein the second metal particles have a different hardness than the first metal particles.

This configuration makes it possible to control the microstructure of the composite metallic material including the first and second metal particles, thus controlling the packability of the green compact under pressure. Thus, the density and mechanical properties of the first current collector can be controlled.

### Technique 14

The battery according to Technique 13, wherein the second metal particles are softer than the first metal particles.

With this configuration, in the green compact under pressure, the second metal particles deform first to fill the voids between the first metal particles. This increases the compactness of the composite metallic material including the first metal particles and the second metal particles, forming a first current collector having high conductivity and high corrosion resistance. Furthermore, the second metal particles in the composite metallic material absorbs stresses caused by thermal expansion of the first metal particles and charging and discharging. Thus, the first current collector having high durability against temperature cycling and charge and discharge cycling can be produced.

### Technique 15

The battery according to Technique 13, wherein the second metal particles are harder than the first metal particles.

With this configuration, in the green compact under pressure, a microstructure in which the second metal particle between the first metal particles has a portion embedded in the first metal particle can be formed. Thus, the second metal particle acts as an anchor connecting the first metal particles, enhancing the connection between the first metal particles. This improves resistance of the first current collector to deflection (e.g., bending) stress and handling, improving the mechanical reliability of the first current collector.

### Technique 16

The battery according to any one of Techniques 8 to 15, wherein the second metal particles have a different potential than the first metal particles.

This configuration allows the electrochemical stability of the first current collector to be adjusted. Furthermore, for example, the first current collector may have a two-layer structure including a layer of the first metal particles and a layer of the second metal particles. This configuration allows the first current collector to have different electrochemical stability at upper and lower surfaces. Thus, the electrochemical stability of the current collector can be controlled depending on the operating potential of the active material and the charge and discharge voltage. This enables a high-performance battery to be highly reliably produced.

### Technique 17

The battery according to any one of Techniques 1 to 16, wherein the first metal particles are composite metal particles including a plurality of metals having different compositions.

This configuration allows properties such as corrosion resistance, thermal expansion, electrochemical stability, and mechanical reliability of the first current collector to be controlled. This enables a high-performance battery having high reliability to be produced.

### Technique 18

The battery according to any one of Techniques 1 to 17, wherein the first metal particles are composite metal particles including a plurality of metals having different potentials.

This configuration enables control of electrochemical stability of the first current collector. This enables a high-performance battery having high reliability to be produced.

### Technique 19

The battery according to any one of Techniques 1 to 18, wherein the first current collector further includes a resin component.

This configuration enhances the mechanical strength of the first current collector and bondability with the first active material layer. Thus, a battery having high reliability against external stresses such as deflection and impact can be produced.

### Technique 20

The battery according to any one of Techniques 1 to 20, wherein the first current collector includes at least one selected from the group consisting of a Si-containing component and a F-containing component.

With this configuration, the first current collector can have high heat resistance and corrosion resistance. The flexibility of the Si-containing or F-containing component can absorb the difference in the thermal expansion coefficient of the joint interface between the Si-containing or F-containing component (e.g., resin component) and the first metal particle, which may be caused by a rapid temperature change. Thus, the Si-containing or F-containing component is less likely to delaminate from the first current collector, and the first current collector can maintain high heat resistance and corrosion resistance. This makes it possible to produce a battery that has high reliability against heat generation in the battery due to high-rate operation such as rapid charging and discharging.

### Technique 21

The battery according to Technique 20, wherein a total volume concentration of the Si-containing component and the F-containing component is higher at an interface between the first current collector and the first active material layer than in an inner portion of the first current collector.

This configuration increases the reliability of the interface between the first current collector, which has the highest ion travel density and tends to generate heat, and the first active material layer, enabling a battery having further improved reliability to be produced.

### Technique 22

The battery according to any one of Techniques 1 to 21, further comprising an electrolyte layer including the electrolyte and disposed between the first electrode and the second electrode, wherein
the electrolyte is a solid electrolyte.

With this configuration, the battery can have further improved reliability.

The batteries according to the present disclosure were described above with reference to the embodiments, but the present disclosure should not be limited to the embodiments. Without departing from the gist of the present disclosure, various changes may be made to the embodiments by a person skilled in the art, and the components in different embodiments may be combined. They are construed as being within the scope of the present disclosure.

Other various modifications, substitutions, additions, or omissions may be performed on the embodiments within or equivalent to the scope of the claims.

The batteries according to the present disclosure can be used as secondary batteries such as solid-state batteries installed in various electrical devices or automobiles.

What is claimed is:

1. A battery comprising:
a first electrode;
a second electrode; and
an electrolyte, wherein
the first electrode includes a first current collector and a first active material layer,
the first current collector is formed of a green compact including first metal particles,
the first metal particles each have a first protection layer on at least a portion of a surface of the first metal particle, and
the first protection layer includes an oxide.

2. The battery according to claim 1, wherein the first protection layer includes an oxide of a metal component forming the first metal particles.

3. The battery according to claim 1, wherein the first protection layer includes a metal oxide containing at least one selected from the group consisting of Al, Zr, Ti, and Si.

4. The battery according to claim 1, wherein the first protection layer includes an amorphous material.

5. The battery according to claim 1, wherein the first protection layer includes two or more oxides having different compositions from each other.

6. The battery according to claim 1, wherein the first protection layer is composed of a multilayer film having two or more layers.

7. The battery according to claim 1, wherein, in the green compact, the first protection layer has a larger volume in a second area that is a void at a grain boundary triple point of the first metal particles than in a first area that is a joint interface between adjacent two of the first metal particles.

8. The battery according to claim 1, wherein the green compact further includes second metal particles, and
the second metal particles include a metal different from a metal forming the first metal particles.

9. The battery according to claim 8, wherein the second metal particles have a smaller average particle diameter than the first metal particles.

10. The battery according to claim 8, wherein the second metal particles each have a second protection layer on at least a portion of a surface of the second metal particle.

11. The battery according to claim 10, wherein the second protection layer is formed of a material having a different composition from a material of the first protection layer.

12. The battery according to claim 10, wherein the second protection layer has a different thickness than the first protection layer.

13. The battery according to claim 8, wherein the second metal particles have a different hardness than the first metal particles.

14. The battery according to claim 8, wherein the second metal particles have a different potential than the first metal particles.

15. The battery according to claim 1, wherein the first metal particles are composite metal particles including a plurality of metals having different compositions.

16. The battery according to claim 1, wherein the first metal particles are composite metal particles including a plurality of metals having different potentials.

17. The battery according to claim 1, wherein the first current collector further includes a resin component.

18. The battery according to claim 1, wherein the first current collector includes at least one selected from the group consisting of a Si-containing component and a F-containing component.

19. The battery according to claim 18, wherein a total volume concentration of the Si-containing component and the F-containing component is higher at an interface between the first current collector and the first active material layer than in an inner portion of the first current collector.

20. The battery according to claim 1, further comprising an electrolyte layer including the electrolyte and disposed between the first electrode and the second electrode, wherein
the electrolyte is a solid electrolyte.
